(19) United States
(12) Patent Application Publication
(10) Pub. No.: US 2025/0390953 A1
(43) Pub. Date: Dec. 25, 2025

(54) GENERATING AN OPTIMIZED CONSTRAINED LINEAR REGRESSION MODEL

(71) Applicant: Asper.AI Inc., New York City, NY (US)

(72) Inventors: Praveen TIWARI, Bangalore (IN); Amandeep CHANYAL, Bangalore (IN); Prashant SHARMA, Bangalore (IN)

(21) Appl. No.: 18/816,661

(22) Filed: Aug. 27, 2024

(30) Foreign Application Priority Data
Jun. 20, 2024 (IN) 202421047559

(51) Int. Cl. G06Q 40/06

(52) U.S. Cl. CPC G06Q 40/06

(57) ABSTRACT

The method comprises receiving one or more bounds for each coefficient of independent variables. Further, a steepness value is selected for controlling the velocity of weight updates for each coefficient. Subsequently, an update vector with a length equal to the number of independent variables may be created. Further, the method may comprise iterating until convergence. Each iteration may include computing a gradient for each independent variable based on the gradient, updating values of each coefficient based on the computed gradient, the computed multiplier, a learning rate, and the update vector. Further, the method involves monitoring the CLR optimization process for convergence based on whether a change in the value of the cost function is below a predefined threshold or a maximum number of iterations is reached. Further, the optimized CLR model may be utilized for at least one application within Revenue Growth Management (RGM).

### PRIORITY INFORMATION

The present application claims priority from Indian Application No. 202421047559 dated Jun. 20, 2024.

### TECHNICAL FIELD

The present subject matter described herein, in general, relates to machine learning and data analytics, specifically to a system and a method for optimizing a Constrained Linear Regression (CLR) model for Revenue Growth Management (RGM) applications.

### BACKGROUND

In the modern retail and e-commerce landscape, businesses continuously adjust pricing and launch promotional campaigns to attract customers and increase sales. Accurately attributing sales to these strategies is crucial for assessing their effectiveness and optimizing future marketing efforts. Traditional sales attribution models, such as simple linear regression or logistic regression, have been widely used to understand the relationship between sales and marketing strategies. However, these models often face several limitations, such as, but not limited to, Static Coefficient Assignment and Lack of Constraints on Variables.

Traditional models typically use static coefficients for variables, assuming constant relationships over time. This assumption fails to capture the dynamic nature of consumer behavior, market conditions, and the effectiveness of marketing strategies, leading to inaccurate attribution. Sales are influenced by a complex interplay of factors, including competitor actions, market trends, and external events. Simplistic models may not adequately account for these factors, oversimplifying the attribution process and potentially misleading decision-making.

Thus, there is a clear need for an improved model that can dynamically adjust to changing market conditions and consumer behaviors, accurately reflecting the contribution of pricing and promotional strategies to sales outcomes.

### SUMMARY

Before the present system(s) and method(s) are described, it is to be understood that this application is not limited to the particular system(s) and methodologies described, as there can be multiple possible embodiments that are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for generating an optimized Constrained Linear Regression (CLR) model for revenue growth management (RGM) application.

In one general aspect, a computer-implemented method may include receiving time series sales data for a Stock Keeping Unit (SKU), where the time series sales data may include information relating to independent variables. The independent variables include one or more of pricing information, promotional data, distribution metrics, competitor activity data, holiday impact, marketing spend, advertisement spend, economic indicators, demographic factors, weather, and seasonality. Further, the method may initialize each coefficient within the CLR model based on at least one of a predefined criteria that include statistical analysis of historical data sets and heuristic methods to ensure initial conditions are optimized for convergence.

The computer-implemented method may also include receiving one or more bounds for a coefficient of an independent variable. The one or more bounds may represent operational constraints related to the independent variable. The one or more bounds may include at least one of a lower limit and an upper limit for the coefficient associated with the independent variable.

The method may furthermore include selecting a steepness value, which is a hyperparameter for controlling a velocity of weight updates for the coefficient. The steepness value allows fine-tuning sensitivity of the CLR model to variations in input data. The method further may include dynamically choosing a learning rate for determining a size of steps taken in a direction of the gradient during the optimization process of the CLR model. The learning rate is adaptively adjusted based on the rate of improvement in the cost function to enhance convergence efficiency.

The method may, in addition, include determining an update vector based on a number of the independent variables present in the time series sales data. Subsequently, the method may include iteratively optimizing the CLR model until convergence. Each iteration may include: computing a gradient of a cost function with respect to the coefficient using data-driven analysis to reflect current market dynamics. Further, the iteration may comprise computing a multiplier for the independent variable based on the gradient. The multiplier may dynamically adjust based on whether the gradient of the cost function is positive or negative. The multiplier may be computed to optimize a response of the CLR model to fluctuating market conditions. Furthermore, the iteration may include updating the coefficient based on the computed gradient, the computed multiplier, a learning rate, and the update vector. The coefficient may be updated to improve accuracy of the CLR model in attributing sales outcomes under varying conditions. Further, the method may involve monitoring optimization process of the CLR model for convergence based on whether a change in value of the cost function is below a predefined threshold or a maximum number of iterations is reached.

Subsequently, the method may involve automatically generating an optimized CLR model having model coefficients defined as the updated coefficients from the iterations. The optimized CLR model provides enhanced attributions for sales outcomes that comply with the one or more bounds. The method may also include executing the optimized CLR model to generate attribution of sales performance in Revenue Growth Management (RGM) applications such as elasticity analysis, sales attribution, and pricing simulation thereby enabling strategic data-driven decision-making. Other embodiments of this aspect include corresponding computer systems, apparatus, and computer programs recorded on one or more computer storage devices, each configured to perform the actions of the methods.

The method further may include setting a stopping criteria for the optimization process. The stopping criteria is dynamically adjusted and include at least one of a predefined number of iterations, a percentage decrease in the cost function, or achieving a minimum threshold for changes in the cost function. The stopping criteria ensure that the model stops training when optimal or sufficiently satisfactory results are achieved.

In one general aspect, a system for generating an optimized CLR model is disclosed. The system may include a memory, a processor, a receiving module, a constraint management module, a hyperparameter tuning module, a vector determination module, an optimization engine, a model generation module, and an execution module. The receiving module may be configured to receive time series sales data for an SKU. The time series sales data may include information relating to independent variables. The independent variables include one or more of pricing information, promotional data, distribution metrics, competitor activity data, holiday impact, marketing spend, advertisement spend, economic indicators, demographic factors, weather, and seasonality. Further, the system may initialize each coefficient within the CLR model based on at least one of a predefined criteria that include statistical analysis of historical data sets and heuristic methods to ensure initial conditions are optimized for convergence.

Further, the constraint management module may receive one or more bounds for each coefficient of the independent variables. The one or more bounds represent operational constraints related to the independent variables. The one or more bounds may include at least one of a lower limit and an upper limit for the coefficient associated with an independent variable of the independent variables.

Further, the hyperparameter tuning module may select a steepness value, which is a hyperparameter for controlling a velocity of weight updates for each coefficient. The steepness value may allow fine-tuning sensitivity of the CLR model to variations in input data. Furthermore, the hyperparameter tuning module may dynamically choosing a learning rate for determining a size of steps taken in a direction of the gradient during the optimization process of the CLR model. The learning rate is adaptively adjusted based on the rate of improvement in the cost function to enhance convergence efficiency.

The system may utilize the vector determination module to determine an update vector based on a number of the independent variables present in the time series sales data. Further, the system may utilize an optimization engine to iteratively optimize the CLR model until convergence. Each iteration may include: computing a gradient of a cost function with respect to each coefficient using data-driven analysis to reflect current market dynamics. Further, the iteration may comprise computing a multiplier for each independent variable based on the gradient. The multiplier may dynamically adjust based on whether the gradient of the cost function is positive or negative. The multiplier is computed to optimize a response of the CLR model to fluctuating market conditions. The iteration may further comprise updating values of each coefficient based on the computed gradient, the computed multiplier, a learning rate, and the update vector. The values of each coefficient are updated to improve accuracy of the CLR model in attributing sales outcomes under varying conditions. Further, the system may monitor optimization process of the CLR model for convergence based on whether a change in value of the cost function is below a predefined threshold or a maximum number of iterations is reached.

Further, the model generation module may automatically generate an optimized CLR model having model coefficients defined as the updated coefficients from the iterations. The optimized CLR model provides enhanced attributions for sales outcomes that comply with the one or more bounds. Furthermore, the execution module may execute the optimized CLR model to generate attributions of sales performance in Revenue Growth Management (RGM) applications such as elasticity analysis, sales attribution, and pricing simulation thereby enabling strategic data-driven decision-making.

In another implementation, a non-transitory computer-readable medium embodying a program executable in a computing device for generating an optimized Constrained Linear Regression (CLR) model is disclosed. The program may comprise a program code for receiving time series sales data for an SKU. The time series sales data comprises information relating to independent variables. Further, the program may comprise a program code for receiving one or more bounds for a coefficient of an independent variable. The one or more bounds represent operational constraints related to the independent variable. Subsequently, the program may comprise a program code for selecting a steepness value, which is a hyperparameter for controlling a velocity of weight updates for the coefficient. The steepness value allows fine-tuning sensitivity of the CLR model to variations in input data. Further, the program may comprise a program code for determining an update vector based on a number of the independent variables present in the time series sales data. Furthermore, the program may comprise a program code for iteratively optimizing the CLR model until convergence, wherein each iteration comprises: computing a gradient of a cost function with respect to the coefficient; computing optimization for the independent variable based on the gradient, wherein the multiplier is dynamically adjusted based on whether the gradient of the cost function is positive or negative, wherein the multiplier is computed to optimize a response of the CLR model to fluctuating market conditions; updating the coefficient based on the computed gradient, the computed multiplier, a learning rate, and the update vector, wherein the coefficient is updated to improve accuracy of the CLR model in attributing sales outcomes under varying conditions; monitoring optimization process of the CLR model for convergence based on whether a change in value of the cost function is below a predefined threshold or a maximum number of iterations is reached. Further, the program may comprise a program code for automatically generate an optimized CLR model having model coefficients defined as the updated coefficients from the iterations, wherein the optimized CLR model provides enhanced attributions for sales outcomes that comply with the one or more bounds. Furthermore, the program may comprise a program code for execute the optimized CLR model to generate attributions of sales performance in Revenue Growth Management (RGM) applications, thereby enabling strategic data-driven decision-making.

### BRIEF DESCRIPTION OF THE DRAWINGS

The foregoing detailed description of embodiments is better understood when read in conjunction with the appended drawings. For the purpose of illustrating of the present subject matter, an example of a construction of the present subject matter is provided as figures, the invention is not limited to the specific method and system for generating an optimized Constrained Linear Regression (CLR) model disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation for generating an optimized Constrained Linear Regression (CLR) model, in accordance with an embodiment of the present subject matter.

FIG. 2 illustrates a method for generating an optimized Constrained Linear Regression (CLR) model, in accordance with an embodiment of the present subject matter.

FIG. 3 illustrates a distribution plot between base price and sales, in accordance with various embodiments of the present subject matter.

FIG. 4 illustrates a system for generating an optimized Constrained Linear Regression (CLR) model, in accordance with various embodiments of the present subject matter.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “executing,” “determining,” “modifying,” “generating,” “attributing,” “selecting,” “computing,” “monitoring,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

The present invention pertains to a computational approach for enhancing attribution modelling techniques specifically tailored for Revenue Growth Management (RGM) in various business sectors. The present method and the system disclose an optimized Constrained Linear Regression (CLR) model that integrates advanced machine learning methods to process and analyze time-series sales data, accommodating a wide array of independent variables such as pricing, promotions, and market dynamics.

The method is implemented on a computer system where it begins by receiving detailed sales data for an SKU. This data includes not only sales figures but also influential factors such as promotional activities, distribution metrics, and external economic conditions. To ensure that the model adheres to realistic business constraints, bounds are defined for each coefficient of the independent variables. These bounds are reflective of operational constraints and are crucial for maintaining the practical applicability of the model attributions.

A steepness value, a critical hyperparameter, is selected to control the rate at which the model's coefficients are updated. The steepness value is essential for fine-tuning the model's sensitivity to input variations, allowing for a more responsive and accurate model. The update vector, determined by the quantity of independent variables, facilitates efficient and effective updates to the coefficients through each iteration of the model optimization.

The iterative optimization process is robust, involving the computation of gradients and multipliers that dynamically adjust based on the direction and magnitude of the cost function's gradient. This adaptive adjustment ensures that the model continuously refines its ability to accurately attribute sales outcomes to different variables under varying conditions. The process persists until the model achieves convergence, defined by specific stopping criteria such as a predetermined threshold in the cost function's improvement or a set number of iterations.

Upon convergence, the optimized CLR model is capable of generating precise attributions for RGM applications, including elasticity analysis, sales attribution, pricing simulation and recommendation, and promotional simulation and recommendation. These applications benefit significantly from the model's ability to incorporate and respect the defined operational constraints, thus providing businesses with reliable and actionable insights for strategic decision-making.

Further enhancing its utility, the model supports the generation of user interfaces for visualization and interaction, alongside recommendations based on its attributions to facilitate informed decision-making across diverse business scenarios. This patent thus presents a significant advancement in the field of business analytics, offering a robust, adaptable, and precise tool for revenue growth management through data-driven insights.

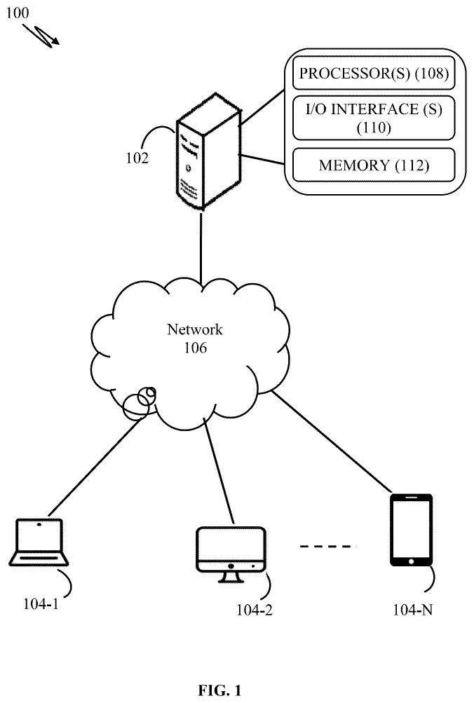

Referring now to FIG. 1, a network implementation 100 of a system 102 for generating an optimized Constrained Linear Regression (CLR) model is disclosed. Initially, the system 102 receives time series sales data. In an example, the software may be installed on a user device 104-1. It may be noted that the one or more users may access the system 102 through one or more user devices 104-1, 104-2, . . . 104-N, collectively referred to as user devices 104, hereinafter, or applications residing on the user devices 104. The system 102 receives time series sales data from one or more user devices 104. Further, the system may also 102 receive a feedback from a user using the user devices 104. Furthermore, the system may also 102 receive feedback and real-time analytics requests from a user using the user devices 104.

Although the present disclosure is explained considering that the system 102 is implemented on a server, it may be understood that the system 102 may be implemented in a variety of computing systems, such as a laptop computer, a desktop computer, a notebook, a mobile device, a workstation, a virtual environment, a mainframe computer, a server, a network server, a cloud-based computing environment. It will be understood that the system 102 may be accessed by multiple users through one or more user devices 104-1, 104-3 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, HyperText Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an input/output (I/O) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the user devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as Wireless Local Area Network (WLAN), cellular, or satellite. The I/O interface 110 may include one or more ports for connecting a number of devices to one another or to another server.

The memory 112 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 for generating an optimized Constrained Linear Regression (CLR) model. At first, a user may use the user device 104 to access the system 102 via the I/O interface 110. The user may register the user devices 104 using the I/O interface 110 in order to use the system 102. In one aspect, the user may access the I/O interface 110 of the system 102. The detailed functioning of the system 102 is described below with the help of figures.

The system may receive data time series sales data for an SKU. It may be noted that the time series sales data also comprises information relating to independent variables. The independent variables include pricing information, promotional data, distribution metrics, competitor activity data, holiday impact, marketing spending, advertisement spending, economic indicators, demographic factors, weather, and seasonality. It may be noted that various independent variables or features impact the sales, thus it is very important to take into variable data while analyzing the sales data.

The time series sales data may be received from an external database source. The external database can include public databases, commercially available databases, or private databases accessible through partnerships or subscriptions. These databases might contain a wide range of data, from financial and economic statistics to demographic and geographic information.

Sales data for an SKU may represent historical and current sales figures, encompassing quantities sold, sales revenue, returns, and sales channels. The sales data provides a foundational understanding of an SKU's performance in the market over time. For instance, sales data might detail how many units of a product were sold online versus in physical stores during the last quarter, or how sales volumes change during promotional periods.

Further to receiving the time-series sales data, the system 102 may perform a series of validation checks to ensure its accuracy and completeness. An accuracy check is essential to verify that the data reflects correct and plausible values. For example, and not by way of any limitation, the system might check for outlier values in sales figures that exceed expected ranges based on historical performance. Further, the system may perform a completeness check to review the data to ensure there are no missing values for any of the key variables. Missing data can be handled through imputation techniques, where missing values are filled based on the median, mean, or another relevant statistic from the data. In an embodiment, the system may identify the independent variable with missing data by determining a deviation from the mean or median of the values of the one or more independent variables. If the deviation is beyond a certain number of standard deviations from the mean or median may be considered as variables with missing data. In yet another embodiment, the system may use statistical analysis and compute mean, median, mode, standard deviation, and the like for each of the variable like product price, discount, promotion offered etc. By computing such statistics, the system may analyse patterns, trends, and anomalies that may indicate the presence of missing values. For example, the system may identify one or more variables with inconsistent or incomplete data patterns compared to other variables in the dataset and are flagged. Further, the system may perform a consistency check to ensure that the data across different sources is consistent and follows the same format and units of measurement, which is crucial for accurate analysis.

Further to data validation, system 102 may prepare the data for modelling by transforming the validated data into a format that is suitable for modelling and can involve normalization/standardization, feature engineering, data partitioning, feature selection. The normalization process involves adjusting data scales to a standard range or distribution, which helps in neutralizing the influence of different unit scales on the model's coefficients. The feature engineering process involves creating new variables (features) from the existing data that may have a significant impact on the dependent variable. This could involve calculating ratios, rolling averages, seasonal adjustments, or interaction terms that are expected to enhance the model's attribution accuracy. Further, the data partitioning involves dividing the dataset into training, validation, and testing sets. This separation is essential for training the model, tuning hyperparameters, and evaluating model performance in a way that mimics real-world application but avoids overfitting. Furthermore, the feature selection is performed before final modelling. The system evaluates and selects the most relevant features to include in the CLR model. This is based on their predictive power and relevance to the specific RGM objectives, such as understanding the impact of pricing changes or promotions on sales. Techniques such as correlation analysis, backward elimination, or machine learning algorithms like random forests can be used to identify the most impactful variables.

The system may initialize the coefficient within the CLR model based on at least one of a predefined criteria that include statistical analysis of historical data sets and heuristic methods to ensure initial conditions are optimized for convergence.

Subsequently, the system may receive one or more bounds for each coefficient of the independent variables. The one or more bounds represent operational constraints related to the independent variables. The one or more bounds may comprise at least one of a lower limit and an upper limit for the coefficient associated with an independent variable. The bounds may also be referred to as constraints or boundaries. The system may plot the distribution of each coefficient for each independent variable using the Linear Regression (LR) model, also referred to as an unconstrained linear regression model. In an example, a distribution plot of the coefficient may help in selecting the one or more bounds for the coefficient. A simple linear regression model, predicting the response variable Y based on one or more independent variables x₁, x₂ . . . xₙ, is given by:

$$y = {β}_{0} + {β}_{1} {x}_{1} + {β}_{2} {x}_{2} … + {β}_{n} {x}_{n} + ε$$

where:
y is the dependent variable
x₁, x₂, . . . xₙ are the independent variables and β₁, β₂, . . . and βₙ are coefficients of the independent variables.
β₀ is the intercept (the value of y when all independent variables are 0).

The one or more bounds are applied to the LR model to create a Constrained Linear Regression (CLR) model by constraining each coefficient within the one or more bounds. In an embodiment, the system may automatically determine the one or more bounds based on at least one percentile-based approach, the R-squared value of the LR model, a set of rules, and business logic. The percentile-based approach may be utilized to capture a specific percentile range in the historical data, ensuring that the model's sensitivity is tuned to typical market conditions. The R-squared value determination may consider the R-squared value of the LR model, which reflects how well the independent variables explain the variability in the dependent variable, thus helping set realistic bounds. In another embodiment, the system may utilize a predefined set of rules and business logic to set the one or more bounds. These rules might be derived from regulatory requirements, historical performance thresholds, or strategic targets that the business aims to maintain.

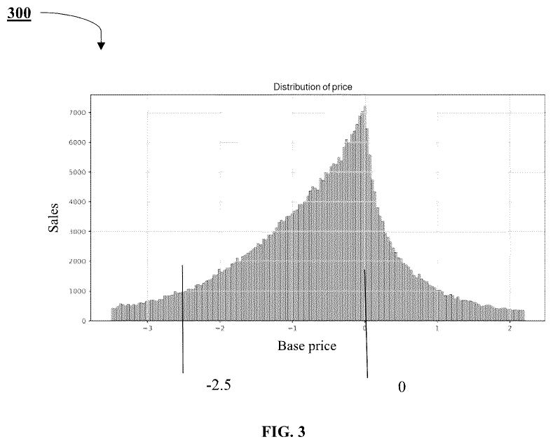

In an embodiment, adding an upper limit and a lower limit to the coefficients of one or more variables of the LR model is referred to as bounding the values of the coefficients. For example, the system determines a probability density function for the coefficients using linear regression models. This graphical representation or distribution plot, as shown in FIG. 3, provides insights into the distributional characteristics of the coefficients over time. The distribution plot 300, for instance, illustrates the base price of an SKU and displays how variations in price have affected sales over time. The coefficient associated with the price variable ranges from −3 to +2. Positive values from 0 to +2 suggest that increases in price correlate with increased sales, which may not always be practically feasible. To achieve a more explainable and reliable outcome, the system bounds the coefficient for the price by setting an upper limit of 0 and a lower limit of −2.5. With these bounds, the system analyzes trends of price with sales only within these limits, thereby focusing further analyses on this specific region.

The system employs a Constrained Linear Regression (CLR) model specifically designed to effectively attribute sales performance to various marketing and environmental factors. This model is pivotal in understanding how each independent variable contributes to overall sales outcomes, providing valuable insights for strategic planning and decision-making. In scenarios where bounds for the coefficients are not predefined, the CLR model defaults to functioning as a normal Linear Regression (LR) model. This flexibility is achieved through a sophisticated wrapper that is implemented on top of the standard LR model, enhancing its capabilities by introducing constraints as needed. This wrapper allows the system to seamlessly transition between a constrained environment, where specific operational bounds guide the model's attributions, offering versatility in how sales data is analyzed and utilized.

Further to defining the constraints, the system may select a steepness value also referred to as a steepness factor (μ). The steepness value (μ) is a hyperparameter for controlling a velocity of weight updates for each coefficient. The steepness value may be specifically designed to control the velocity at which the weights, or coefficients, of the model are updated during the learning process. By adjusting the steepness value, the system can finely tune the CLR model's sensitivity to variations in the input data. This fine-tuning is essential because it allows the model to react appropriately to different scales of input changes-ensuring that the model remains robust and responsive without overreacting to minor fluctuations.

The steepness factor (μ) controls the rate at which the model adjusts the coefficients when nearing the defined boundaries. For example, if a coefficient is near the upper limit of 3.5 (e.g., coefficient at 3.49), the steepness factor (μ) regulates the model's coefficient adjustments to prevent it from exceeding this boundary.

As the coefficient approaches the bounds, the steepness factor directs the model to modify other variable coefficients. This strategy ensures that the model does not overly depend on any single feature, thus maintaining balanced adjustments across all variables.

The steepness factor facilitates the inclusion of the elasticity of other features in the model's optimization process. This means that the model, influenced by the steepness factor, adjusts to incorporate how responsive other variables are to changes, ensuring a comprehensive optimization approach.

The steepness factor (μ) is utilized for fine-tuning the model's sensitivity to variations in input data, allowing precise control over how the model's attributions respond to different data inputs. This fine-tuning capability is essential for optimizing the accuracy and relevance of attribution results, ensuring that the model accurately reflects the impact of various marketing variables on sales outcomes.

In an exemplary embodiment, let's assume that the independent variables impacting sales are advertising spend (ads), marketing spend, and discounts offered. The system may receive bounds for the independent variables such as ads are constrained between 0 to 1.5, marketing from 0 to 1.0, and discounts from 0 to 0.8.

Further, the system may identify that the coefficient for advertising spend is nearing its upper limit, currently valued at 1.48, close to the upper bound of 1.5. This proximity triggers a moderation mechanism controlled by a steepness factor, a key hyperparameter within the CLR model. The steepness factor strategically reduces the update velocity of the ads coefficient as it approaches its upper bound, thereby preventing it from exceeding the limit and potentially distorting the model's attribution accuracy.

The system may evaluate the coefficients of the other variables-marketing and discounts. Given the moderated adjustment to the advertising spend coefficient, the system explores opportunities to enhance the influence of marketing and discounts, assuming the incoming data supports their effectiveness. Suppose the analysis suggests that an increased emphasis on marketing and discounts could beneficially impact sales; the coefficients for marketing and discounts might be incrementally adjusted from 0.6 to 0.65 and from 0.5 to 0.55, respectively.

Such adjustment to the coefficient of marketing and discount ensures that the model maintains a balanced sensitivity across all variables, effectively distributing the influence on the attributed sales outcomes. The CLR model continues to process iterations, adapting coefficients within their constraints, ensuring all adjustments are data-driven and reflect current market conditions. This methodical rebalancing and continuous optimization exemplify the model's capability to adapt dynamically, ensuring robustness and reliability in its outputs.

Further, the system 102 may select a learning rate for the CLR model. The learning rate determines a size of steps taken in a direction of a gradient during the optimization process of the CLR model. It may be noted that the steepness value is independent of the learning rate. The steepness value and the learning rate are hyperparameters for the CLR model and are tuned based on hyperparameter tuning methods.

In another embodiment, the system may determine an optimal learning rate for the Constrained Linear Regression (CLR) model. The learning rate influences the magnitude of adjustments made to the model's coefficients during each iteration of the optimization process. Specifically, the learning rate dictates the size of the steps taken along the gradient of the cost function, which represents the direction and rate at which the model should adjust its coefficients to minimize errors in attributions.

The choice of an appropriate learning rate is pivotal for the efficiency and effectiveness of the CLR model's training phase. If set too high, the learning rate may cause the CLR model to oscillate around the minimum or even diverge, failing to converge to an optimal solution. The learning rate that is too low may result in a prolonged convergence process, significantly slowing down the model's training and potentially leading to suboptimal performance if the training is prematurely terminated.

To optimize the learning process and enhance the CLR model's responsiveness to data, the system 102 is designed to select and adjust the learning rate from a predefined range specific to an SKU. For instance, let us assume that the learning rate for the model can vary between 0.003 and 0.009. Initially, the learning rate might be selected as 0.003 based on hyperparameter tuning methods. During the initial training phase, this learning rate is maintained fixed to assess the model's performance under these settings. Based on the outcomes of this first trial, the system may modify the learning rate; in an exemplary embodiment, the learning rate might be adjusted to 0.005. This modification is made using hyperparameter tuning methods, which evaluate the model's performance and adapt the learning rate to optimize convergence. It should be noted that the adjustment of the learning rate, though potentially beneficial for overcoming issues like stagnation in minimally changing cost functions or escaping shallow local minima, is strategically employed to finely balance rapid convergence with the stability of the learning trajectory.

The dynamic adjustment helps to balance the trade-off between the speed of convergence and the stability of the learning process, ensuring that the CLR model efficiently reaches a high level of accuracy. The adaptively adjusted learning rate plays a fundamental role in maintaining the robustness of the CLR model, ensuring that it remains sensitive to changes in the input data while avoiding overfitting or underfitting. This capability significantly enhances the model's utility in real-world applications, where it can provide reliable and actionable insights for Revenue Growth Management strategies.

Further, the system 102 may determine an update vector (θ) based on a number of the independent variables (F) present in the time series sales data. Let's assume that the system receives time series sales data from an external data source. The system analyses the time series data and determines the number of independent variables impacting the sales. In an example, if there are five independent variables, the system may initialize the update vector with five binary elements, each set to 1, indicating that initially, all coefficients are eligible for updates. In an embodiment, the system may create an update vector (θ) with size=length (F) and initialize all values with 1.

The purpose of setting the update vector with binary values is to ensure that each coefficient associated with the independent variables can be selectively updated based on the model's optimization logic. The update vector may influence whether the adjustments (change) are applied to each coefficient during the model's iterative learning process, based on whether each respective element of the update vector is 1 (update) or 0 (no update).

In an embodiment, the update vector is utilized to manage the bounds of certain coefficients to prevent updates beyond a predefined thresholds and the coefficients comprise at least an average price coefficient exceeding a base price.

Further, the system may set a stopping criteria for an optimization process of the CLR model. The stopping criteria may be dynamically adjusted and may include at least one of a predefined number of iterations, a percentage decrease in the cost function, achieving a minimum threshold for changes in the cost function, or a change in the coefficients that is less than a predefined threshold. The stopping criteria may ensure that the CLR model stops training when optimal or sufficiently satisfactory results are achieved.

In an example, a user may set the predefined number of iterations referring to a maximum limit on the number of iterations the model undergoes. This limit prevents overfitting by restricting the training process after a certain number of adjustments have been made to the model's coefficients, thereby ensuring that the model does not continue to learn from noise or redundant data after substantial convergence has been achieved.

In another example, the stopping criteria for the optimization process is determined by a specified percentage decrease in the cost function criteria. This criterion involves monitoring the reduction in the cost function, which quantifies the error or loss the model incurs. A predefined percentage decrease in this function indicates that further training yields diminishing returns, signalling an effective time to halt further adjustments. This method ensures that the training process is economically efficient, focusing resources only until significant improvements are realized.

‘In yet another example, the stopping criteria may be determined by achieving a minimum threshold for changes in the cost function. This stopping criterion is set to identify minimal adjustments in the cost function's value, indicative of the model reaching a plateau in learning. When changes in the cost function fall below this threshold, it suggests that subsequent iterations are unlikely to yield significant improvements, and continuing the optimization would not be an effective use of computational resources.

In yet another embodiment, the optimization process may converge when the change in the coefficients, commonly referred to as beta, between successive iterations, falls below a predetermined threshold. The predetermined threshold may be selected based on the specific requirements and sensitivity of the application to ensure that the model's parameters do not continue to fluctuate beyond a minimal acceptable range. By monitoring the changes in the coefficients, the system can effectively determine when the model has reached a point of parameter stability, indicating that further iterations are unlikely to yield significant improvements or adjustments in the model's attribution accuracy.

By integrating these dynamically adjusted stopping criteria, the system ensures that the CLR model ceases training precisely when optimal or sufficiently satisfactory results are achieved. This not only enhances the model's generalization capability by preventing overfitting but also optimizes computational resources by avoiding unnecessary processing. Furthermore, it assures that the CLR model remains robust and adaptable, capable of delivering high-quality attribution outputs that are crucial for effective decision-making in Revenue Growth Management applications. This approach, therefore, ensures that the model is both cost-effective and highly accurate, aligning with the overarching goals of maximizing efficiency and effectiveness in predictive analytics.

Further to setting the stopping criteria, the system may iteratively optimize the CLR model until convergence. The iteration may comprise computing a gradient of a cost function with respect to each coefficient using data-driven analysis to reflect current market dynamics. The gradient is targeted at minimizing the objective function, typically the Root Mean Squared Error (RMSE), which measures an error of the CLR model.

$$∇ J ( θ ) = \frac{1}{m} {\sum }_{i = 1}^{m} ( ( {h}_{θ} ( {x}^{( i )} ) - {y}^{( i )} ) \cdot {x}^{( i )} )$$

where J(θ) is the cost function, h_{θ} [symbol] (x [symbol] ⁽ⁱ⁾) is the predicted value for the i^{th} example, y⁽ⁱ⁾ is the actual value, x⁽ⁱ⁾ is the feature vector for the i^{th} example, and m is the number of training examples.

The iteration further comprises computing a multiplier (γ) for each independent variable based on the gradient. The multiplier may dynamically adjust based on whether the gradient of the cost function is positive or negative. The multiplier may be computed to optimize a response of the CLR model to fluctuating market conditions. The multiplier is computed based on the below equation:

$$∇ J ( θ ) >= 0 then γ = e \hat{} ( μ \cdot ( ( θ\_j - L\_ ( j ) ) ) / ( U\_j - L\_j ) ) - 1 / 2 ) )$$

$$∇ J ( θ ) < 0 then γ = e \hat{} ( μ \cdot ( ( {U}_{j} - θ\_ ( j ) ) ) / ( Uj - Lj ) ) - 1 / 2 ) )$$

Wherein μ is the steepness value

Further to computing the multiplier, the system may update values of each coefficient based on the computed gradient, the computed multiplier, a learning rate, and the update vector. The values of each coefficient are updated to improve accuracy of the CLR model in attributing sales outcomes under varying conditions. The values of each coefficient is updated based on the below equation:

$$θ := θ - ∝ \cdot γ \cdot ϑ \cdot ∇ J ( θ )$$

wherein θ is an update vector. The system may determine the update vector (θ) with size=length (F) and initialize all values with 1.
wherein ∝ is the learning rate, γ is the multiplier; and ∇J(θ) is the gradient.

Further to updating the value of the coefficient, the system validates the updated values of each coefficient within the received bounds for each coefficient of the independent variables. In another embodiment, the system may restrict the 0 values within bounds Lⱼ, Uⱼ for all j in F.

In an exemplary embodiment, the system may evaluate the sum of the coefficients (θⱼ) associated with “average price” independent variable. Further, the system may compare this sum against the sum of the absolute values of the coefficients [symbol] abs(θ [symbol] ⱼ) associated with “base price” variables. Below is the equation for comparison:

$$\sum j in average price variables {θ}_{j} \geq \sum j in base price variables abs ( {θ}_{j} ) then$$

$$Set ϑ = 0 for j in average and base price variables$$

$$Else ϑ = 1 for j in F$$

In the exemplary embodiment, the system may selectively set specific values of the update vector to zero based on a comparison of sum of absolute values of the updated coefficients against the corresponding bounds of the coefficient, specifically for independent variables categorized under average price and the base price. In another embodiment, this customization in the update vector may vary.

Further, the system may monitor optimization process of the CLR model for convergence based on at least one of whether a change in the value of the cost function J(θ) is below a predefined threshold, a maximum number of iterations is reached, and a change in the coefficient is less than a predefined threshold. Once the convergence is completed, the system terminates the algorithm and return the optimized parameter or coefficient (θ).

Further to iteratively optimizing the CLR model, the system may automatically generate an optimized CLR model having model coefficients defined as the updated coefficients from the iterations. The optimized CLR model provides enhanced attributions for sales outcomes that comply with the one or more bounds.

Further, the optimized CLR model may be executed to generate attributions of sales performance in Revenue Growth Management (RGM) applications such as elasticity analysis, sales attribution, and pricing simulation thereby enabling strategic data-driven decision-making.

In an embodiment, the CLR model may be utilized to assesses changes in various factors (independent variables), such as price or marketing expenditure, might affect sales volume. By understanding the elasticity of demand for different SKUs, businesses can strategically adjust prices to optimize revenue without detrimentally affecting sales volume.

In another embodiment, the CLR model may be utilized for sales attribution. The CLR model attributes changes in sales performance to specific actions or market conditions. For instance, the model may distinguish between the impact of a marketing campaign and a seasonal effect on sales increases, thereby clarifying which factors are driving revenue changes and warranting investment.

In yet another embodiment, the CLR model simulates various pricing scenarios, allowing businesses to attribute outcomes of different pricing strategies. This simulation enables companies to forecast the results of price changes and develop pricing strategies that maximize profits while staying competitive in the market.

Further, the system may generate a user interface on a display of the user device for visualizing the optimized CLR model and enabling user interactions. It may be noted that the recommendations may be provided based on the optimized CLR model to facilitate data-driven decision-making across a diverse array of business scenarios.

The system comprises an I/O interface 110. The interface 110 may present a visual representation of the optimized Constrained Linear Regression (CLR) model, offering intuitive access for users to interact with the model's functionality. This interface not only graphically depicts the model's analytics, such as variable impacts and sales attribution, but also enables users to input new data, adjust parameters, and run simulations in real-time. Additionally, the system may leverage the insights derived from the CLR model to provide actionable recommendations, guiding users towards optimal decisions in a variety of business scenarios. These recommendations, rooted in the sophisticated data analysis performed by the model, support users in navigating complex market dynamics and formulating strategies that are substantiated by robust data-driven evidence, thus enhancing the strategic decision-making process across different facets of business operations.

In an example and not by way of any limitation, a user, such as a revenue manager, interacts with a computing device equipped with the optimized CLR model to make informed strategic decisions. Upon initiating the CLR model via a user interface on the device, the manager inputs current market data, including recent sales figures, pricing changes, and ongoing promotional details. The model, leveraging its advanced algorithms and the computational power of the device, processes this data to generate sales attribution insights with high precision.

As the model executes, it conducts elasticity analysis, attributing recent sales fluctuations to specific variables such as a recent advertising campaign or a competitor's pricing strategy. The user is presented with a clear, actionable report on the device's display, detailing the sales attribution in response to various potential actions. With these insights, the manager can simulate different pricing scenarios, evaluating the potential impact of each on sales revenue, all within the bounds of the model's constraints to ensure practical applicability.

This interaction showcases the invention's utility, rooted in the technology that bridges the gap between complex data analysis and user-friendly decision support. The device, through the CLR model, becomes an indispensable tool in the manager's workflow, allowing for rapid, data-driven strategy formulation that is responsive to the latest market conditions. The tangible outputs, derived from the internal workings of the model, underscore the tangible benefits of this technological advancement in the realm of Revenue Growth Management.

In an example, let's assume that company A installs the system for revenue growth management purposes. Initially, the system may receive historical sales data of the company A. Let's assume that the company A sells multiple SKUs. In this scenario, the system will receive the time series sales data for multiple products. Further, the system may receive upper bound and lower bound for each coefficient of the independent variables of each SKU. The bounds may be provided by the company A. In another embodiment, the system may determine the bounds for the company A by analysing distribution plot of each coefficient.

Further, the system may select a learning rate and a steepness value as hyperparameters of the CLR model. Let's assume that the system determines that the number of independent variable present in the sales data are 3. The system may defined the update vector as 3. Further, the optimization process of the CLR model commences, driven by an iterative computation of the gradient of the cost function concerning each coefficient. This computation reflects the current market dynamics and indicates the modifications required to enhance the CLR model's attribution accuracy. The system further calculates multipliers for each independent variable based on the gradient's direction and magnitude. The multipliers are dynamically adjusted to finetune the model's responsiveness, ensuring that each iteration hones in on the most accurate attribution possible. Throughout this process, the system monitors the cost function's value changes against the defined stopping criteria. Once it detects that the change in value is beneath a predefined threshold or that the maximum number of iterations is reached, the optimization is deemed complete, signaling convergence.

Upon achieving convergence, the system generates the optimized CLR model, characterized by the refined coefficients that have been iteratively adjusted within the set bounds. This optimized model is then executed, yielding enhanced sales attribution of Company A's SKUs across various RGM applications, including elasticity analysis, sales attribution, and pricing simulation.

The output provided by the system equips Company A with data-driven recommendations, enabling strategic decisions such as recalibrating marketing expenditures, scheduling promotions, and adjusting prices—all tailored to optimize revenue growth while staying within the strategic confines defined by the operational bounds.

In another example, let's assume that a retail chain plans to optimize its stock levels and promotional discounts for a range of products. Using the CLR model, the retailer processes historical sales data, including variables such as past discounts offered, customer footfall, and local economic indicators. By establishing bounds for the discount coefficient based on past sales performance and budget constraints, the retailer ensures that promotional strategies do not erode profit margins. Through iterative optimization, the model adapts to the changing effectiveness of discounts on sales. The resulting optimized CLR model guides the retailer in setting strategic discounts that boost sales without compromising on profitability. The model also aids in attributing stock levels required to meet the anticipated demand generated by these discounts, thus optimizing inventory management and reducing waste from overstocking.

Let's consider an example where a beverage company is using a Constrained Linear Regression (CLR) model to optimize the sales strategy for Coca-Cola™ in the New York region. The company may aim to understand the impact of different factors on Coca-Cola™ sales in New York and adjust its strategies accordingly. The company may employ the CLR model with specific coefficients that quantify the influence of pricing and market penetration factors.

### Coefficients and Their Interpretations:

Coefficient of Base Price (−0.64): This value indicates that increasing the base price of Coca-Cola by 1% is expected to decrease sales by approximately 0.64%. This negative relationship underscores the sensitivity of sales to price increases.

Coefficient of ACV Distribution (1.08): ACV (All Commodity Volume) distribution measures the product's market penetration. A coefficient of 1.08 suggests that improving the product's penetration (availability in more stores or larger stores) by 1% could lead to a 1.08% increase in sales, highlighting the importance of extensive distribution networks.

Coefficient of External Competition Average Price (0.11): This indicates that a 1% increase in the average price of external competitors, like Pepsi™, could increase Coca-Cola's sales by 0.11%. This suggests a modest sensitivity to competitor pricing.

Coefficient of Internal Competition Average Price (0.21): Similarly, a 1% increase in the price of internal competing products (such as Sprite™ or Fanta™) might lead to a 0.21% increase in Coca-Cola™ sales, possibly due to consumers substituting Coca-Cola™ for these slightly more expensive alternatives.

### Hyperparameters Tuning:

Learning Rate (0.003): The learning rate is used to adjust how much the coefficients change in response to the gradient in each iteration. A lower learning rate helps prevent overshooting during optimization.

Steepness (5): The steepness factor influences how rapidly the model responds to changes in the gradient. A higher steepness value leads to more significant adjustments, enhancing the model's sensitivity to shifts in underlying data patterns.

Bounds: Each coefficient has defined bounds/constraints to ensure the CLR model remains realistic and aligns with business constraints:

Base Price: [−2.5, 0]-Prevents the model from recommending a price increase beyond a certain threshold.

ACV Distribution: [0, 1.5]-Caps the expected positive impact of distribution to maintain realistic growth projections.

External Competition Average Price: [0, 1]-Limits the influence of competitors' pricing on the model's output.

Internal Competition Average Price: [0, 1]-Restricts the impact of pricing from other company products to prevent unrealistic cross-elasticity effects.

Practical Application: In practical terms, the company may use the CLR model to simulate various scenarios and make informed decisions. For instance, if competitor prices rise, the model can predict how much Coca-Cola™ might benefit from either holding prices steady or implementing a slight increase. If the model indicates approaching the upper bound of base price sensitivity, the company might focus more on enhancing distribution rather than pushing price increases.

By continually updating the CLR model with actual sales data and revisiting the coefficients and bounds, the company can maintain a dynamic approach to managing Coca-Cola's™ market presence in New York, ensuring strategies remain optimally aligned with current market conditions and consumer behaviour.

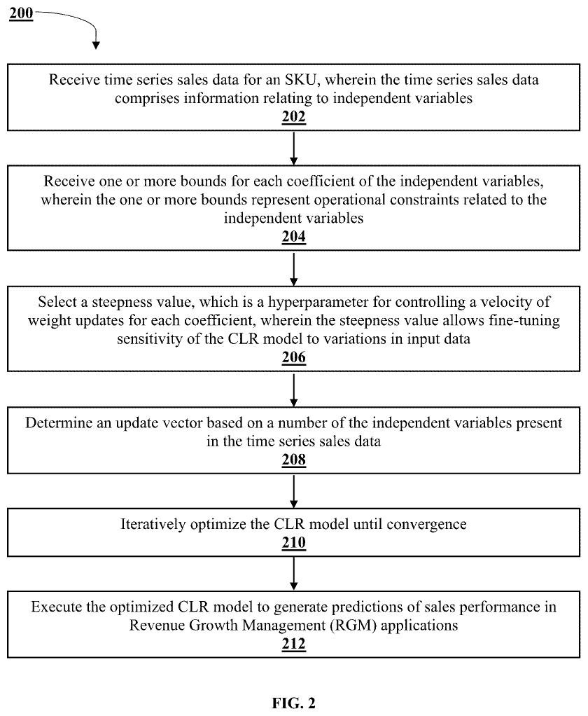

Referring now to FIG. 2, a method 200 for generating an optimized Constrained Linear Regression (CLR) model is shown, in accordance with an embodiment of the present subject matter. The method 200 may be described in the general context of computer executable instructions. Generally, computer executable instructions can include routines, programs, objects, components, data structures, procedures, modules, functions, etc., that perform particular functions or implement particular abstract data types.

The order in which the method 200 is described is not intended to be construed as a limitation, and any number of the described method blocks can be combined in any order to implement the method 200 or alternate methods for generating an optimized Constrained Linear Regression (CLR) model. Additionally, individual blocks may be deleted from the method 200 without departing from the scope of the subject matter described herein. Furthermore, the method 200 for generating an optimized Constrained Linear Regression (CLR) model can be implemented in any suitable hardware, software, firmware, or combination thereof. However, for ease of explanation, in the embodiments described below, the method 200 may be considered to be implemented in the system 102.

At step 202, time series sales data may be received for an SKU. The time series sales data may include information relating to independent variables. The independent variables include one or more of pricing information, promotional data, distribution metrics, competitor activity data, holiday impact, marketing spend, advertisement spend, economic indicators, demographic factors, weather, and seasonality.

At step 204, one or more bounds for each coefficient of the independent variables may be received. The one or more bounds may represent operational constraints related to the independent variables. The one or more bounds may include at least one of a lower limit and an upper limit for the coefficient associated with an independent variable of the independent variables.

At step 206, a steepness value for the CLR model may be selected. The steepness value or steepness factor is a hyperparameter for controlling a velocity of weight updates for each coefficient. The steepness value allows fine-tuning sensitivity of the CLR model to variations in input data.

At step 208, an update vector may be determined based on a number of the independent variables present in the time series sales data.

At step 210, the CLR model may be iteratively optimized until convergence. Each iteration may include: computing a gradient of a cost function with respect to each coefficient using data-driven analysis to reflect current market dynamics. The gradient reflects changes needed to improve attribution accuracy of the CLR model. Further, the iteration may comprise computing a multiplier for each independent variable based on the gradient. The multiplier may dynamically adjust based on whether the gradient of the cost function is positive or negative. The multiplier may be computed to optimize a response of the CLR model to fluctuating market conditions. Furthermore, the iteration may include updating values of each coefficient based on the computed gradient, the computed multiplier, a learning rate, and the update vector. The values of each coefficient may be updated to improve accuracy of the CLR model in sales attribution outcomes under varying conditions. Further, the method may involve monitoring optimization process of the CLR model for convergence based on whether a change in value of the cost function is below a predefined threshold or a maximum number of iterations is reached.

At step 212, the method may comprise automatically generating an optimized CLR model having model coefficients defined as the updated coefficients from the iterations. The optimized CLR model provides enhanced sales attribution that comply with the one or more bounds. The method may also include executing the optimized CLR model to generate sales attribution in Revenue Growth Management (RGM) applications such as elasticity analysis, sales attribution, and pricing simulation thereby enabling strategic data-driven decision-making. Other embodiments of this aspect include corresponding computer systems, apparatus, and computer programs recorded on one or more computer storage devices, each configured to perform the actions of the methods.

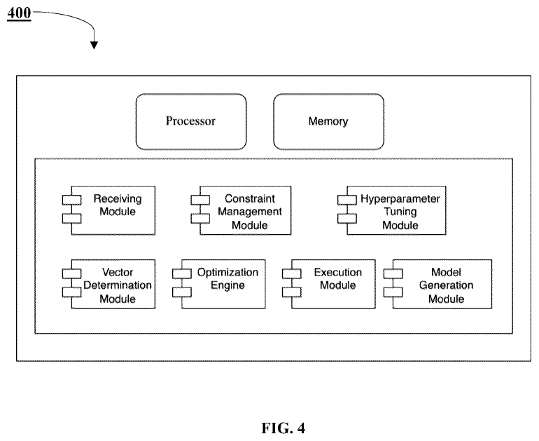

FIG. 4 illustrates a block diagram 400 depicting a system for generating an optimized Constrained Linear Regression (CLR) model, according to an embodiment of the present disclosure. The block diagram comprises a memory, a processor, a receiving module, a constraint management module, a hyperparameter tuning module, a vector determination module, an optimization engine, a monitoring module, a model generation module, and an execution module.

The receiving module may be configured to receive time series sales data for an SKU. The time series sales data comprises information relating to independent variables.

Further, the constraint management module may receive and manage one or more bounds for a coefficient of an independent variable. The one or more bounds represent operational constraints related to the independent variable.

The hyperparameter tuning module may be configured to select a steepness value and a learning rate. The steepness value controls a velocity of weight updates for the coefficient. The steepness value allows fine-tuning sensitivity of the CLR model to variations in input data. The learning rate determines a size of steps taken in a direction of a gradient during the optimization process of the CLR model. It may be noted that the steepness value is independent of the learning rate.

The vector determination module may determine an update vector based on a number of the independent variables present in the time series sales data. The update vector may influence whether the adjustments (change) are applied to each coefficient during the model's iterative learning process, based on whether each respective element of the update vector is 1 (update) or 0 (no update).

The optimization engine further comprises a Gradient Computation Unit, a Multiplier Computation Unit, a Coefficient Update Unit. The gradient computation unit is configured to compute a gradient of a cost function with respect to the coefficient. Further, the Multiplier Computation Unit computes a multiplier for the independent variable based on the gradient. The multiplier is dynamically adjusted based on whether the gradient of the cost function is positive or negative. Furthermore, the Coefficient Update Unit is configured to update the coefficient based on the computed gradient, the computed multiplier, a learning rate, and the update vector. The coefficient is updated to improve accuracy of the CLR model in attributing sales outcomes under varying conditions.

Further, a monitoring module may be configured to monitor optimization process of the CLR model for convergence based on whether a change in value of the cost function is below a predefined threshold or a maximum number of iterations is reached.

The model generation module may be configured to automatically generate an optimized CLR model having model coefficients defined as the updated coefficients from the iterations. The optimized CLR model provides enhanced attributions for sales outcomes that comply with the one or more bounds.

Further, an execution module may be configured to execute the optimized CLR model to generate attributions of sales performance in Revenue Growth Management (RGM) applications, thereby enabling strategic data-driven decision-making. The RGM applications comprise at least one of elasticity analysis, sales attribution, pricing simulation and recommendation, and promotional simulation and recommendation.

Exemplary embodiments discussed above may provide certain advantages. Though not required to practice aspects of the disclosure, these advantages may include those provided by the following features.

Some embodiments of the system and method enable the integration of complex, real-world constraints directly into the CLR model, ensuring that the outputs are not only statistically valid but also operationally feasible and aligned with business objectives.

Some embodiments of the system and method enable dynamic adjustment of model parameters in real-time, allowing the model to adapt quickly to changing market conditions and data inputs, which improves the reliability and accuracy of the sales attribution.

Some embodiments of the system and method enable a detailed visualization of predictive outcomes through user interfaces, facilitating easier interpretation and interaction with the CLR model's results, which can enhance decision-making processes across business units.

Some embodiments of the system and method enable the use of a steepness value as a hyperparameter, which fine-tunes the responsiveness of the model to fluctuations in input data, thereby optimizing the speed and stability of the model's convergence.

Some embodiments of the system and method enable the optimization process to be automatically monitored and adjusted based on predefined criteria such as the number of iterations or the magnitude of change in the cost function, thus ensuring efficient use of computational resources and reducing the time to achieve optimal results.

Some embodiments of the system and method enable the application of machine learning techniques to dynamically select and adjust the learning rate during the model's training phase, which helps to avoid overshooting the minimum of the cost function and enhances the overall performance of the model.

Some embodiments of the system and method enable the CLR model to handle a wide array of independent variables, from economic indicators to weather conditions, providing a comprehensive tool for Revenue Growth Management that is sensitive to a broad spectrum of influencing factors.

Some embodiments of the system and method enable the preservation of coefficient boundaries through the use of an update vector, which prevents the model from violating operational limits during optimization, thereby maintaining the integrity and applicability of the model in real-world scenarios.

Some embodiments of the system and method enable dynamic adaptation of the model to continuously changing market conditions. By utilizing real-time data to adjust coefficients within the constraints set by business needs, the model remains relevant and effective, providing reliable sales attribution that help businesses respond proactively to market shifts.

Some embodiments of the system and method enable an understanding of the impact of pricing strategies and promotional activities on sales. By accurately attributing sales outcomes to these variables within constrained parameters, businesses can fine-tune their strategies to maximize revenue and market share.

Some embodiments of the system and method enable the optimization of computational resources through the implementation of a steepness factor in the gradient descent algorithm. This factor controls the velocity of coefficient updates, allowing the system to make more targeted and efficient adjustments. By minimizing unnecessary recalculations and refining the approach to data processing, the model significantly reduces computational overhead. This leads to faster model training and prediction times, optimizing system performance and enabling more efficient handling of large datasets.

Some embodiments of the system and method enable dynamic adaptation of the learning rate based on real-time analysis of model performance. This functionality allows the system to automatically adjust the learning rate, enhancing the model's ability to converge on optimal solutions more quickly and with greater accuracy. As a result, the computing system continuously improves its functionality, adapting to new data without manual recalibration. This automated tuning not only ensures the model remains effective over time but also reduces the computational burden associated with manual adjustments, leading to a more responsive and robust attribution modelling system.

Although implementations for methods and system for generating an optimized Constrained Linear Regression (CLR) model have been described in language specific to structural features and/or methods, it is to be understood that the appended claims are not necessarily limited to the specific features or methods described. Rather, the specific features and methods are disclosed as examples of implementations for generating an optimized Constrained Linear Regression (CLR) model.

1. A computer implemented method for optimizing computational resources during training of a Constrained Linear Regression (CLR) model to prevent coefficient updates from exceeding bounds while maintaining convergence speed through dynamic multiplier adjustment, the method comprising:
receiving, by a processor, time series sales data for an SKU, wherein the time series sales data comprises information relating to independent variables;
receiving, by the processor, one or more bounds or constraints for a coefficient of an independent variables, wherein the one or more bounds represent operational constraints related to the independent variable;
fine-tuning sensitivity of the CLR model to variations in input data based on a steepness value which is a hyperparameter distinct from a learning rate that controls a velocity of weight updates for the coefficient by regulating coefficient adjustments when approaching the one or more bounds to prevent boundary violations while maintaining model convergence;
for an initial training phase, determining, by the processor, the learning rate for the CLR model and maintaining the learning rate for at least one training phase to evaluate CLR model performance;
determining, by the processor, an update vector based on a number of the independent variables present in the time series sales data, wherein the update vector comprises binary elements that selectively enable coefficient updates based on coefficient proximity to the one or more bounds;
dynamically adjusting, by the processor, a stopping criteria for the CLR model optimization process, the stopping criteria comprising at least one of: (i) a specified percentage decrease in a cost function; (ii) an absolute change in the cost function less than a minimum threshold; or (iii) a change in coefficient values between successive iterations less than a predetermined threshold; and, responsive to satisfaction of any one of the stopping criteria, declaring convergence and terminating the optimization of the CLR model;
iteratively optimizing, by the processor, the CLR model until convergence, wherein each iteration comprises:
computing, by the processor, a gradient of the cost function with respect to the coefficient;
automatically adjusting, by the processor, the learning rate to optimize convergence speed of the CLR model based on performance metrics from the initial training phase;
computing, by the processor, a multiplier for the independent variable based on the gradient, wherein the multiplier is dynamically adjusted based on whether the gradient of the cost function is positive or negative, wherein the multiplier is computed to optimize a response of the CLR model to fluctuating market conditions;
updating, by the processor, the coefficient based on the computed gradient, the computed multiplier, the learning rate, and the update vector, wherein the coefficient is updated to improve accuracy of the CLR model in attributing sales outcomes under varying conditions; and
monitoring, by the processor, optimization process of the CLR model for convergence based on whether a change in value of the cost function is below a predefined threshold or a maximum number of iterations is reached;
automatically generating, by the processor, an optimized CLR model having model coefficient defined as the updated coefficients that remain constrained within the one or more bounds throughout the iterative optimization process; and
executing, by the processor, the optimized CLR model to generate attributions of sales performance in Revenue Growth Management (RGM) applications.

2. The method as claimed in claim 1, wherein the independent variables include one or more of pricing information, promotional data, distribution metrics, competitor activity data, holiday impact, marketing spend, advertisement spend, economic indicators, demographic factors, weather, and seasonality.

3. The method as claimed in claim 1, wherein the one or more bounds comprises at least one of a lower limit and an upper limit for the coefficient associated with the independent variable.

4. The method, as claimed in claim 1, wherein the coefficient within the CLR model is initialized based on at least one of a predefined criteria that include statistical analysis of historical data sets and heuristic methods to ensure initial conditions are optimized for convergence.

5. The method, as claimed in claim 1, wherein the RGM applications comprise at least one of elasticity analysis, sales attribution, pricing simulation and recommendation, and promotional simulation and recommendation.

6. The method as claimed in claim 1, wherein the learning rate is automatically adjusted by monitoring performance metrics of the CLR model, and wherein the performance metrics comprise at least one of: a change in the cost function, a convergence rate threshold, or oscillations in coefficient values.

7. (canceled)

8. The method as claimed in claim 1, further comprises initializing values within the update vector to unity, wherein the update vector facilitates coefficient updates.

9. The method as claimed in claim 1, wherein the update vector is utilized to manage the bounds of the coefficients to prevent updates beyond a predefined thresholds.

10. The method as claimed in claim 1, wherein updating the coefficient further comprises validating the updated coefficient within the received bounds for the coefficient of the independent variable.

11. The method as claimed in claim 1, further comprises:
generating a user interface on a display device for visualizing the optimized CLR model and enabling user interactions; and
providing recommendations based on the optimized CLR model to facilitate data-driven decision-making across a diverse array of business scenarios.

12. A system for optimizing computational resources during training of a Constrained Linear Regression (CLR) model to prevent coefficient updates from exceeding bounds while maintaining convergence speed through dynamic multiplier adjustment, the system comprising:
a memory; and
a processor coupled to the memory, wherein the processor is configured to execute a set of instructions stored in the memory to:
receive, by a receiving module, time series sales data for an SKU, wherein the time series sales data comprises information relating to independent variables;
receive, by a constraint management module, one or more bounds for a coefficient of an independent variable, wherein the one or more bounds represent operational constraints related to the independent variable;
fine-tune sensitivity of the CLR model to variations in input data based on a steepness value which is a hyperparameter distinct from a learning rate that controls a velocity of weight updates for the coefficient by regulating coefficient adjustments when approaching the one or more bounds to prevent boundary violations while maintaining model convergence;
for an initial training phase, determine the learning rate for the CLR model and maintaining the learning rate for at least one training phase to evaluate CLR model performance;
determine, by a vector determination module, an update vector based on a number of the independent variables present in the time series sales data, wherein the update vector comprises binary elements that selectively enable coefficient updates based on coefficient proximity to the one or more bounds;
dynamically adjusting a stopping criteria for the CLR model optimization process, the stopping criteria comprising at least one of: (i) a specified percentage decrease in a cost function; (ii) an absolute change in the cost function less than a minimum threshold; or (iii) a change in coefficient values between successive iterations less than a predetermined threshold; and, responsive to satisfaction of any one of the stopping criteria, declaring convergence and terminating the optimization of the CLR model;
iteratively optimize, by an optimization engine, the CLR model until convergence, wherein each iteration comprises:
compute a gradient of the cost function with respect to the coefficient;
automatically adjust the learning rate to optimize convergence speed of the CLR model based on performance metrics from the initial training phase;
compute a multiplier for the independent variable based on the gradient, wherein the multiplier is dynamically adjusted based on whether the gradient of the cost function is positive or negative, wherein the multiplier is computed to optimize a response of the CLR model to fluctuating market conditions;
update the coefficient based on the computed gradient, the computed multiplier, the learning rate, and the update vector, wherein the coefficient is updated to improve accuracy of the CLR model in attributing sales outcomes under varying conditions; and
monitor optimization process of the CLR model for convergence based on whether a change in value of the cost function is below a predefined threshold or a maximum number of iterations is reached;
automatically generate, by a model generation module, an optimized CLR model having model coefficients that remain constrained within the one or more bounds throughout the iterative optimization process; and
execute, by an execution module, the optimized CLR model to generate attributions of sales performance in Revenue Growth Management (RGM) applications.

13. The system as claimed in claim 12, wherein the independent variables include one or more of pricing information, promotional data, distribution metrics, competitor activity data, holiday impact, marketing spend, advertisement spend, economic indicators, demographic factors, weather, and seasonality.

14. The system as claimed in claim 12, wherein the one or more bounds comprises at least one of a lower limit and an upper limit for the coefficient associated with the independent variable.

15. The system as claimed in claim 12, wherein the coefficient within the CLR model is initialized based on at least one of a predefined criteria that include statistical analysis of historical data sets and heuristic methods to ensure initial conditions are optimized for convergence.

16. The system as claimed in claim 12, further comprise dynamically selecting a learning rate for determining a size of steps taken in a direction of the gradient during the optimization process of the CLR model.

17. (canceled)

18. The system as claimed in claim 12, wherein updating the coefficient further comprises validating the updated coefficient within the received bounds for the coefficient of the independent variable.

19. A non-transitory computer program product having embodied thereon a computer program for optimizing computational resources during training of a Constrained Linear Regression (CLR) model to prevent coefficient updates from exceeding bounds while maintaining convergence speed through dynamic multiplier adjustment, the computer program product storing instructions for:
receive time series sales data for an SKU, wherein the time series sales data comprises information relating to independent variables;
receive one or more bounds for a coefficient of an independent variable, wherein the one or more bounds represent operational constraints related to the independent variable;
fine-tune sensitivity of the CLR model to variations in input data based on a steepness value which is a hyperparameter distinct from a learning rate that controls a velocity of weight updates for the coefficient by regulating coefficient adjustments when approaching the one or more bounds to prevent boundary violations while maintaining model convergence;
for an initial training phase, determine the learning rate for the CLR model and maintaining the learning rate for at least one training phase to evaluate CLR model performance;
determine an update vector based on a number of the independent variables present in the time series sales data, wherein the update vector comprises binary elements that selectively enable coefficient updates based on coefficient proximity to the one or more bounds;
dynamically adjust a stopping criteria for the CLR model optimization process, the stopping criteria comprising at least one of: (i) a specified percentage decrease in a cost function; (ii) an absolute change in the cost function less than a minimum threshold; or (iii) a change in coefficient values between successive iterations less than a predetermined threshold; and, responsive to satisfaction of any one of the stopping criteria, declaring convergence and terminating the optimization of the CLR model;
iteratively optimize the CLR model until convergence, wherein each iteration comprises:
compute a gradient of the cost function with respect to the coefficient;
automatically adjust the learning rate to optimize convergence speed of the CLR model based on performance metrics from the initial training phase;
compute a multiplier for the independent variable based on the gradient, wherein the multiplier is dynamically adjusted based on whether the gradient of the cost function is positive or negative, wherein the multiplier is computed to optimize a response of the CLR model to fluctuating market conditions;
update the coefficient based on the computed gradient, the computed multiplier, the learning rate, and the update vector, wherein the coefficient is updated to improve accuracy of the CLR model in attributing sales outcomes under varying conditions; and
monitor optimization process of the CLR model for convergence based on whether a change in value of the cost function is below a predefined threshold or a maximum number of iterations is reached;
automatically generate an optimized CLR model having model coefficients defined as the updated coefficients that remain constrained within the one or more bounds throughout the iterative optimization process; and
execute the optimized CLR model to generate attributions of sales performance in Revenue Growth Management (RGM) applications.
